(19) United States
(12) Patent Application Publication
(10) Pub. No.: US 2004/0191684 A1
(43) Pub. Date: Sep. 30, 2004

(54) Optical recording medium and method for producing the same

(75) Inventors: Tatsuya Maruyama, Minato-ku (JP); Katsunori Kawano, Ashigarakami-gun (JP); Jiro Minabe, Ashigarakami-gun (JP); Shin Yasuda, Ashigarakami-gun (JP); Norie Matsui, Ashigarakami-gun (JP); Tsutomu Ishii, Ebina-shi (JP); Kazuhiro Hama, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/805,355

(22) Filed: Mar. 22, 2004

(30) Foreign Application Priority Data
Mar. 24, 2003 (JP) 2003-81291
Feb. 16, 2004 (JP) 2004-38694

(51) Int. Cl. G11B 5/58

(52) U.S. Cl. 430/270.11

(57) ABSTRACT

An optical recording medium including a recording layer which is formed into a predetermined shape with a thickness of 0.1 mm to 5 mm and which contains a polyester represented by the following formula (1).

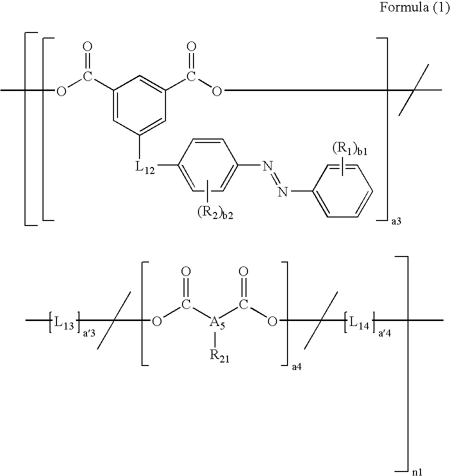

### CROSS-REFERENCE TO RELATED APPLICATION

This application claims priority under 35 USC 119 from Japanese patent Application Nos. 2003-81291 and 2004-38694, the disclosures of which are incorporated by reference herein.

### BACKGROUND OF THE INVENTION

1. Field of the Invention

The present invention relates to an optical recording medium and a method for producing such an optical recording medium. More particularly, the invention relates to a rewritable optical recording medium having a thick recording layer and a method suitably employed for producing such an optical recording medium.

2. Description of the Related Art

Conventionally, rewritable optical disk recording media, such as 12 cm-diameter DVD-RAM capable of high-density, double-sided recording of 5.2 GByte (Gigabyte) with a phase change system, have already been widely used. However, in these optical disk recording media, since data are recorded in a plane, high-density recording is restricted by diffraction limit of light and has come close to a physical limitation. In order to achieve a higher recording capacity, a three-dimensional (volume) recording system including a depth direction is required.

With respect to the above-mentioned volume recording medium, a refractive-index altering material medium (photorefractive material medium) and the like, which allow a volume-recording such as hologram lattices, have been regarded as prospective media. Among photorefractive materials (hereinafter, referred to as “PR materials”), those having high sensitivity and capability of refractive index change with comparatively weak light in a solid laser level, have been known. Such materials are expected to be applied to a volume multiple hologram recording system capable of achieving ultra-high density and ultra-high capacity recording.

Conventionally, inorganic ferroelectric crystals, such as barium titanate, lithium niobate and BSO, have been widely used as the PR material. These materials exhibit a photo-induced refractive-index altering effect (photorefractive effect) with high sensitivity and high efficiency. However, these materials also have defects such as: (i) crystal growth is difficult in the case of many of these materials; (ii) since these materials are hard and fragile, they are hard to form in a desired shape; and (iii) it is difficult to adjust response wavelengths of these materials.

In recent years, PR materials composed of organic substances have been proposed, which solve these problems. However, the problem with these organic PR materials is that the organic PR materials inherently require an application of an external electric field. This electric field needs to be set in a high level of several hundreds of V·mm⁻¹. Such requirement of high electric field imposes a great mechanical limitation upon actually utilizing this system as a recording device. Moreover, in each of these materials, several kinds of different materials, such as a charge-generating material, a charge-transferring material and a polymer substrate, are used in a mixed manner. Such mixture causes a serious problem of degradation in stability due to phase separation at the time of recording or storage.

In order to avoid the above-mentioned problems, for example, S. Hvilsted et al have proposed a method in which a polymer having cyanoazobenzene on a side chain is used to write refractive index lattices by utilizing photo-induced anisotropy so that hologram recording is achieved (see Opt. Lett., 17[17], 1234-1236 (1992)). In this material, for example, it has been revealed that 2500 lattices of refractive index variation can be written within a width of 1 mm, and high recording density has been expected. Moreover, for example, the inventors of the present invention also have proposed various polyesters having azobenzene on a side chain which are useful for achieving photorecording materials (see Japanese Patent Application Laid-Open (JP-A) Nos. 2000-109719, 2000-264962 and 2001-294652).

A holographic memory of a polymer film having azobenzene on a side chain utilizes photo-induced anisotropy of the polymer film. Azobenzene molecules in an amorphous-state azopolymer film are in a randomly oriented state. When linearly polarized excitation light corresponding to an absorbing band of π-π* transition of the azo group is applied to the azo polymer film, the trans-state azobenzene is selectively excited and photo-isomerized to take the cis-state. The term “selectively” means that a trans-state azobenzene group whose transition dipole moment have a direction closer to the direction of polarizing direction, is excited and photo-isomerized with higher probability. The cis-state azobenzene, which is in an excited state, is again isomerized to the trans-state upon application of light or heat.

After passing through such an angle-selective trans-cis-trans isomerizing cycle due to the polarized irradiation, the azobenzene changes its orientation to a stable direction with respect to the excited light, that is, to a direction perpendicular to the polarizing direction. Since the azobenzene has an optical anisotropy, it exerts birefringence and dichroism as a result of the change in its orientation. By utilizing this photo-induced anisotropy, hologram derived from intensity distribution and polarization distribution can be recorded. Since this recording is based on the change in orientation of the polymer, it is stable for a long time, and can be erased by circular polarization irradiation or a heating process to isotropic phase. Hence, such hologram recording can be repeated. In this manner, as materials used for rewritable holographic memory, films of polymers having azobenzene on their side chain are the most prospective materials.

Here, in order to achieve a large capacity in the volume holographic memory, “a thicker recording layer” is the most important factor. In general, the thicker the hologram, the narrower the incident angle conditions for allowing diffraction, and only a slight offset from Bragg conditions causes diffraction light to disappear. The angle multiplexing method in the volume holographic memory utilizes this angle selectivity. In other words, plural holograms are formed in the same volume, and by controlling the incident angle of reading light, it becomes possible to read a desired hologram without crosstalk. In this manner, by increasing the film thickness of the recording layer so as to improve the angle selectivity, the multiplicity can be increased so that the recording capacity is increased.

In general, the photo-induced birefringence of crystalline and liquid crystalline polymers is large, stable to heat, and superior in record retaining property. However, when the crystalline or liquid crystalline polymer film is made thicker, scattering noise caused by crystal increases, resulting in generation of errors upon reading data. Existence of these problems limits the thickness of a recording layer in the conventional holographic memory to approximately 20 μm to 40 μm. Therefore, in order to make the film thicker while preventing the generation of noise and maintaining a high record retaining property, control of the polymer crystallinity is important.

Here, the volume holographic memory requires a thicker film having thickness of at least 100 μm in order to achieve a greater capacity. Upon manufacturing a recording layer of a DVD or the like, a spin coating method is used. However, in general, it is difficult to provide a layer having a thickness of at least 100 μm with the spin coating method. Further, in the case of a casting method, it is difficult to provide an even film thickness. Furthermore, in the case of a plastic substrate, the spin coating method and the casting method may possibly melt the substrate. Consequently, it is difficult to form a recording layer having a thickness of at least 100 μm with the conventional film-forming methods.

### SUMMARY OF THE INVENTION

Considering the above-mentioned problems, an object of the invention is to provide an optical recording medium including a thicker recording layer capable of high-volume recording without impairing recording characteristics. Another objective of the invention is to provide a manufacturing method for an optical recording medium, which can increase the film thickness of the recording layer without impairing recording characteristics.

A first aspect of the present invention is to provide an optical recording medium including a recording layer which is formed into a predetermined shape with a thickness of 0.1 mm to 5 mm and which contains a polyester represented by the following formula (1).

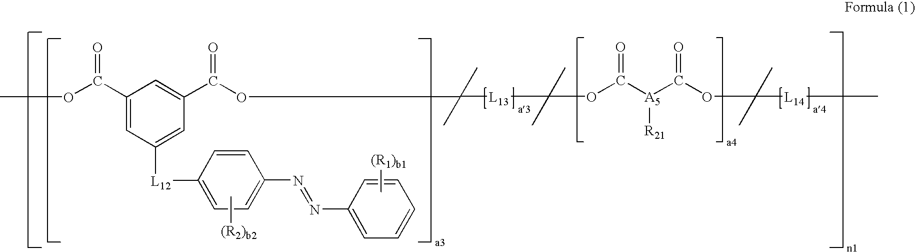

In formula (1), R₁ and R₂ each independently represent a hydrogen atom or a substituent; b1 represents an integer from 0 to 5; b2 represents an integer from 0 to 4; when b1 is 2 or more, plural R₁ may be the same as or different from each other and the plural R₁ may form a ring by being linked with each other; when b2 is 2 or more, plural R₂ may be the same as or different from each other and the plural R₂ may form a ring by being linked with each other; R₂₁ represents a hydrogen atom or a substituent; A₅ represents a divalent linking group when R₂₁ is a hydrogen atom, and A₅ represents a trivalent linking group when R₂₁ is a substituent; L₁₂ to L₁₄ each independently represent a divalent linking group; a3 represents a number from 0.0001 to 1; a4 represents a number from 0 to 0.9999; a3 and a4 satisfy a3+a4=1; a'3 represents a number from 0 to 1; and a'4 represents a number from 0 to 1; a'3 and a'4 satisfy a'3+a'4=1; and n1 represents an integer from 4 to 2000.

A second aspect of the present invention is to provide a method of producing an optical recording medium in which a recording layer including a photo-responsive polymer material is sandwiched between a pair of protective substrates. The method includes: injection molding the photo-responsive polymer material into a plate shape having a thickness of 0.1 mm to 5 mm; and hot-pressing the molded polymer material sandwiched between the pair of protective substrates so that the molded polymer material is fused with the pair of protective substrates to form an optical recording medium.

A third aspect of the present invention is to provide a method of producing an optical recording medium having a recording layer including a photo-responsive polymer material. The method includes: forming the photo-responsive polymer material into a plate shape having a thickness of 0.1 mm to 5 mm by hot-pressing; and using the formed polymer material to produce an optical recording medium.

According to the present invention, it is possible to provide a thicker recording layer without impairing its recording characteristics, and also to achieve an optical recording medium capable of a high-volume recording. Moreover, the invention makes it possible to provide a method of producing an optical recording medium capable of providing a thicker recording layer without impairing its recording characteristics. In particular, a method for forming the recording layer by injection-molding enables the mass-production of the optical recording medium.

### BRIEF DESCRIPTION OF THE DRAWINGS

FIG. 1 is a perspective view that shows the external appearance of an optical recording medium according to the present invention.

FIG. 2 is a cross-sectional view that shows an example of a layer constitution of an optical recording medium according to the invention.

FIG. 3 is a schematic drawing that shows a structure of a vacuum hot-press device.

FIG. 4 is a cross-sectional view that shows another example of a layer constitution of an optical recording medium according to the invention.

FIG. 5 is an explanatory drawing that shows a method of forming a thick layer by using the vacuum hot-press device shown in FIG. 3.

### DETAILED DESCRIPTION OF THE INVENTION

The optical recording medium of the invention includes a recording layer which is formed into a predetermined shape with a thickness of 0.1 mm to 5 mm and contains a polyester represented by the following formula (1). This optical recording medium has, for example, a structure in which a recording layer is formed into a plate shape, and sandwiched between a pair of protective substrates.

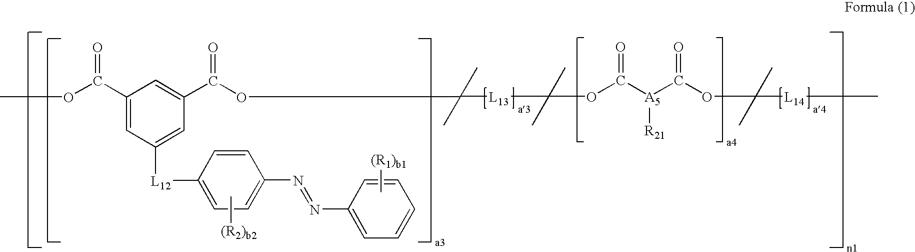

In formula (1), R₁ and R₂ each independently represent a hydrogen atom or a substituent; b1 represents an integer from 0 to 5; b2 represents an integer from 0 to 4; when b1 is 2 or more, plural R₁ may be the same as or different from each other and the plural R₁ may form a ring by being linked with each other; when b2 is 2 or more, plural R₂ may be the same as or different from each other and the plural R₂ may form a ring by being linked with each other; R₂₁ represents a hydrogen atom or a substituent; A₅ represents a divalent linking group when R₂₁ is a hydrogen atom, and A₅ represents a trivalent linking group when R₂₁ is a substituent; L₁₂ to L₁₄ each independently represent a divalent linking group; a3 represents a number from 0.0001 to 1; a4 represents a number from 0 to 0.9999; a3 and a4 satisfy a3+a4=1; a'3 represents a number from 0 to 1; and a'4 represents a number from 0 to 1; a'3 and a'4 satisfy a'3+a'4=l; and n1 represents an integer from 4 to 2000.

The optical recording medium of the invention contains a polyester represented by the above-mentioned formula (1) in its recording layer. By introducing a liquid crystalline linear mesogen group such as a biphenyl derivative or the like into the polyester, it becomes possible to reinforce and fix an orientation change, due to light, of a photo-responsive group, such as azobenzene, which is geometrically isomerized upon irradiation of light. In other words, by introducing the “liquid crystalline linear mesogen group” which does not undergo geometric isomerization, the amount of absorption by pigments is controlled to reduce absorption loss, and high recording sensitivity and high diffraction efficiency can be maintained due to the orientation properties of the liquid crystalline linear mesogen group. As a result, it becomes possible to make the film thicker. In this manner, even in the case of a film thickness of 0.1 mm or more, recording characteristics of this material are not damaged by the influence of light absorption or scattering. Moreover, the glass transition temperature (Tg) thereof is as low as approximately 50° C. Therefore, the recording layer can be formed into a predetermined shape having a thickness of 0.1 mm to 5 mm by using a molding method such as injection molding. In other words, it is possible to make the recording layer thicker without impairing the recording characteristics, and consequently to provide an optical recording medium capable of high-volume recording.

A method for producing an optical recording medium of a first embodiment of the present invention is a method for forming an optical recording medium in which a recording layer made from a photo-responsive polymer material is sandwiched between a pair of protective substrates. The method includes the steps of molding the photo-responsive polymer material into a plate shape having a thickness of 0.1 mm to 5 mm, hot-pressing the molded matter sandwiched between a pair of protective substrates so that the molded matter is fused with the pair of protective substrates to form an optical recording medium.

In the method of producing an optical recording medium of the first embodiment, after the photo-responsive polymer material has been molded into a plate shape having a thickness of 0.1 mm to 5 mm by an injection molding process, the molded matter is sandwiched between a pair of protective substrates, and hot-pressed. Hence, the residual distortion of the molded matter caused by the injection molding is uniformed. Therefore, even in the case when the molded matter having a film thickness of at least 0.1 mm is used as a recording layer, the recording characteristics are not damaged by the influence of light absorption or scattering. Moreover, by using the injection molding upon formation of the recording layer, mass production of the optical recording medium becomes possible.

A method for producing an optical recording medium of a second embodiment of the present invention is a method for forming an optical recording medium having a recording layer made from a photo-responsive polymer material. The method includes molding the photo-responsive polymer material into a plate shape having a thickness of 0.1 mm to 5 mm through a hot-press process, and producing the optical recording medium by using the molded matter.

In the method of producing an optical recording medium of the second embodiment, the photo-responsive polymer material is molded into a plate shape having a thickness of 0.1 mm to 5 mm through the hot-press process. The molded matter formed by the hot-press process does not have residual distortion, and even in the case of a film thickness of at least 0.1 mm, the recording characteristics are not damaged by the influence of light absorption or scattering.

The above-mentioned methods of producing an optical recording medium of the first and second embodiments are suitably applied to a case in which the photo-responsive polymer material contains a polyester represented by the above-mentioned formula (1).

The following description will detail the embodiments of the present invention with reference to the figures.

### First Embodiment

(Optical Recording Medium)

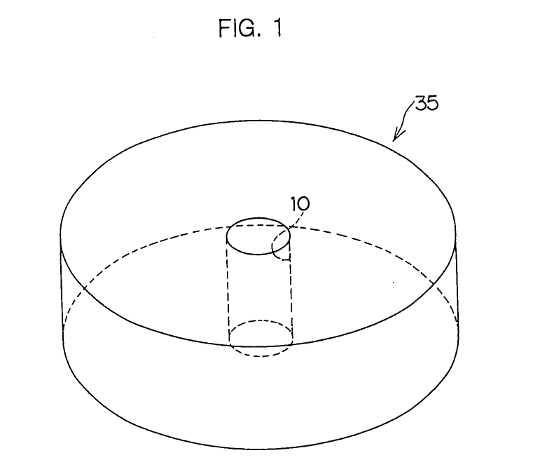

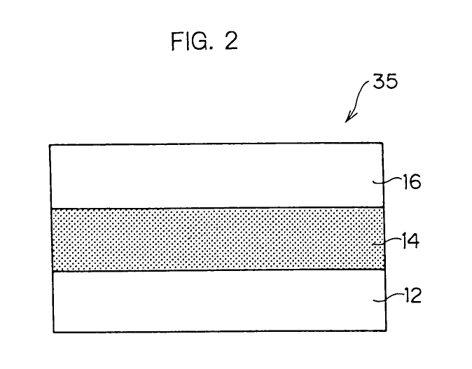

As shown in FIG. 1, an optical recording medium 35 according to a first embodiment is a disc-shaped recording medium having a center hole 10 formed in the center. And, as shown in FIG. 2, the optical recording medium 35 is constituted by a recording layer 14 and a pair of transparent substrates 12 and 16 that sandwich the recording layer 14.

Transparent plastic substrates can be used as the transparent substrates 12 and 16. Here, “transparent” refers to the fact that the substrates are transparent with respect to recording light and reproducing light. Examples of the material for the plastic substrates include polycarbonate; acrylic resins such as polymethyl methacrylate; vinylchloride-based resins such as polyvinylchloride and a copolymer of vinylchloride; epoxy resins; amorphous polyolefin and polyester. From the viewpoint of moisture resistance, dimensional stability and price, polycarbonate is particularly preferable. Moreover, in order to improve bonding performances in hot-pressing processes which will be described later, the transparent substrates 12 and 16 preferably have a Tg which is higher than that of the material of the recording layer 14. For example, Tg of polycarbonate is 150° C.

The thickness of each of the transparent substrates 12 and 16 is preferably from 0.1 to 1 mm. One of the transparent substrates 12 and 16 may be provided with a concave and convex pattern (pregrooves) that is used as guide grooves for tracking or represents information such as address signals.

Holograms can be recorded in the recording layer 14 by changing the refractive index or absorption coefficient of the recording layer 14. The recording layer 14 may be composed of any material as long as it maintains the changed refractive index or absorption coefficient at normal temperature. Examples of the preferable material include photo-responsive materials that exhibit photo-induced birefringence. Those materials that exhibit photo-induced birefringence respond to a polarizing state of incident light, and can record the polarizing direction of the incident light. Here, the optical recording medium in which photo-induced birefringence holograms corresponding to the polarization distribution can be recorded is referred to as an optical recording medium sensitive to polarization.

As material that exhibits photo-induced birefringence, a polymer or a polymer crystal having a photo-isomerizable group on its side chain, or a polymer in which photo-isomerizable molecules are dispersed, is preferably used. With respect to the photo-isomerizable group or molecules, for example, those materials having an azobenzene skeleton are preferably used.

The following description will discuss the principle of photo-induced birefringence, using azobenzene as an example. As shown in the following chemical formulae, azobenzene is allowed to exhibit a trans-cis photo-isomerizing property when irradiated with light. Prior to the irradiation of a photorecording layer with light, many trans-state azobenzene molecules exist in the photorecording layer. These molecules are randomly oriented, and are isotropic from a macroscopic viewpoint. When linearly polarizing light is irradiated to the photorecording layer in a predetermined direction indicated by an arrow, a trans1-state molecule having an absorption axis in the same orientation as the polarizing orientation is selectively photo-isomerized into a cis-state. Molecules which have been relaxed to take a trans2-state having an absorption axis orthogonal to the polarizing orientation, no longer absorb light, and are fixed in the state. Consequently, from a macroscopic viewpoint, the anisotropy of the absorption coefficient and refractive index, that is, dichroism and birefringence, are induced. In general, these characteristics are referred to as photo-induced birefringence, photo-induced dichroism or photo-induced anisotropy. By applying circular-polarizing or non-polarizing light, the excited anisotropy can be erased.

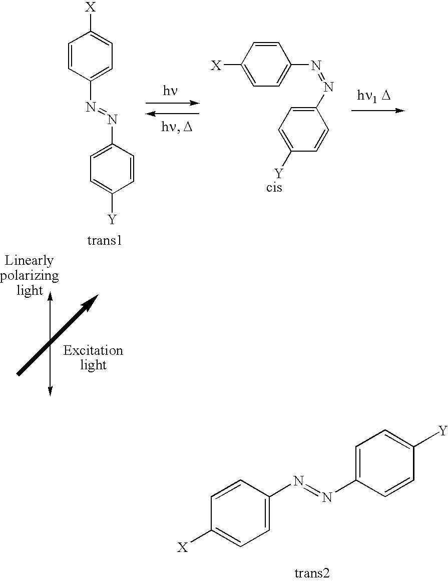

The orientation of such a polymer having a photo-isomerizable group is also changed by the photo-isomerization to induce greater birefringence. The birefringence thus induced is stable at a temperature lower than the glass transition temperature of the polymer, and preferably used for hologram recording.

Preferable examples of the materials constituting the recording layer 14 include polyester having azobenzene in its side chain (hereinafter, referred to as “azopolymer”), which is represented by the following formula (1). Azobenzene on the side chain of this polyester is photo-isomerized to give photo-induced anisotropy. The intensity and polarizing direction of signal light can be recorded as holograms by using the polyester due to the photo-induced anisotropy. Among polyesters of this kind, in particular, polyesters having cyanoazobenzene on their side chain are preferably used. (“Holographic recording and retrieval of polarized light by use of polyester containing cyanoazobenzene units in the side chain”, K. Kawano. T. Ishii, J. Minabe, Ti. Niitsu, Y. Nishikata and K. Baba, Opt. Lett. Vol. 24 (1999) pp. 1269-1271).

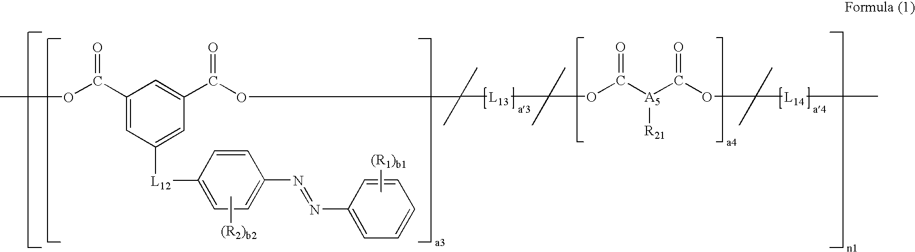

In the formula (1), R₁ and R₂ each independently represent a hydrogen atom or a substituent. b1 represents an integer from 0 to 5, and b2 represents an integer from 0 to 4. When b1 is 2 or more, plural R₁ may be the same as or different from each other and they may form a ring by being linked with each other. When b2 is 2 or more, plural R₂ may be the same as or different from each other and they may form a ring by being linked with each other. R₂₁ represents a hydrogen atom or a substituent. A₅ represents a divalent linking group when R₂₁ is a hydrogen atom, and A₅ represents a trivalent linking group when R₂₁ is a substituent. to L₁₄ each independently represent a divalent linking group. a3 represents a number from 0.0001 to 1, a4 represents a number from 0 to 0.9999, and a3 and a4 satisfy a3+a4=1. a'3 represents a number from 0 to 1, a'4 represents a number from 0 to 1, and a'3 and a'4 satisfy a'3+a'4=1. n1 represents an integer from 4 to 2000.

R₁ and R₂ in the formula (1) each independently represent a hydrogen atom or a substituent. Preferable examples of the substituent include alkyl groups (preferably having 1 to 20 carbon atoms, for example methyl, ethyl, n-propyl, isopropyl, n-butyl, n-pentyl, benzyl, 3-sulfoylpropyl, carboxymethyl, trifluoromethyl and chloromethyl groups), alkenyl groups (preferably having 2 to 20 carbon atoms, for example vinyl, allyl, 2-butenyl and 1,3-butadienyl groups), cycloalkyl groups (preferably having 3 to 20 carbon atoms, for example cyclopentyl and cyclohexyl groups), aryl groups (preferably having 6 to 20 carbon atoms, for example phenyl, 2-chlorophenyl, 4-methoxyphenyl, 3-methylphenyl and 1-naphthyl groups), heterocyclic groups (preferably having 1 to 20 carbon atoms, for example pyridyl, pyrimidyl, thienyl, furyl, thiazolyl, imidazolyl, pyrazolyl, pyrrolidino, piperidino and morpholino groups), alkynyl groups (preferably having 2 to 20 carbon atoms, for example ethinyl, 2-propynyl, 1,3-butadinyl and 2-phenylethynyl groups), halogen atoms (for example F, Cl, Br and I), amino groups (preferably having 0 to 20 carbon atoms, for example amino, dimethylamino, diethylamino, dibutylamino and anilino groups), cyano group, nitro group, hydroxyl group, mercapto group, carboxyl group, sulfo group, sulfonic acid group, acyl groups (preferably having 1 to 20 carbon atoms, for example acetyl, benzoyl, salicyloyl and pyvaloyl groups), alkoxy group (preferably having 1 to 20 carbon atoms, for example methoxy, butoxy and cyclohexyloxy groups), aryloxy groups (preferably having 6 to 26 carbon atoms, for example phenoxy, 1-naphthoxy groups), alkylthio group (preferably having 1 to 20 carbon atoms, for example methylthio and ethylthio groups), arylthio groups (preferably having 6 to 20 carbon atoms, for example phenylthio and 4-chlorophenylthio groups), alkylsulfonyl groups (preferably having 1 to 20 carbon atoms, for example methanesulfonyl and butanesulfonyl groups), arylsulfonyl groups (preferably having 6 to 20 carbon atoms, for example benzenesulfonyl and paratoluenesulfonyl groups), sulfamoyl groups (preferably having 0 to 20 carbon atoms, for example sulfamoyl, N-methylsulfamoyl and N-phenylsulfampyl groups), carbamoyl groups (preferably having 1 to 20 carbon atoms, for example carbamoyl, N-methylcarbamoyl, N,N-dimethylcarbamoyl and N-phenylcarbamoyl), acylamino groups (preferably having 1 to 20 carbon atoms, for example acetylamino and benzoylamino groups), imino groups (preferably having 2 to 20 carbon atoms, for example phthalimino group), acyloxy groups (preferably having 1 to 20 carbon atoms, for example acetyloxy and benzoyloxy groups), alkoxycarbonyl groups (preferably having 2 to 20 carbon atoms, for example methoxycarbonyl and phenoxycarbonyl groups), carbamoylamino groups (preferably having 1 to 20 carbon atoms, for example carbamoylamino, N-methyl carbamoylamino and N-phenyl carbamoylamino groups); more preferably represents alkyl group, cycloalkyl group, aryl group, heterocyclic group, halogen atom, amino group, cyano group, nitro group, hydroxyl group, carboxyl group, sulfo group, alkoxy group, aryloxy group, alkylsulfonyl group, arylsulfonyl group, sulfamoyl group, carbamoyl group, acylamino group, acyloxy group, and alkoxycarbonyl group; and further preferably represents alkyl group, halogen atom, amino group, cyano group, nitro group, hydroxyl group, carboxyl group, alkoxy group, alkylsulfonyl group, sulfamoyl group, carbamoyl group, acylamino group, acyloxy group and alkoxycarbonyl group.

In the formula (1), b1 represents an integer from 0 to 5, preferably an integer from 0 to 2 and more preferably 0 or 1; and b2 represents an integer from 0 to 4, preferably an integer from 0 to 2 and more preferably 0 or 1.

When b1 is 2 or more, plural R₁, may be the same as or different from each other and they may form a ring by being linked with each other. When b2 is 2 or more, plural R₂ may be the same as or different from each other and they may form a ring by being linked with each other. The ring formed is preferably a benzene ring, naphthalene ring, pyridine ring, cyclohexene ring, cyclopentene ring, thiophene ring, furan ring, imidazole ring, thiazole ring, isothiazole ring or oxazole ring.

In the formula (1), R₂₁ represents a hydrogen atom or a substituent. Examples of the substituent include alkyl groups (preferably having 1 to 20 carbon atoms, for example methyl, ethyl, n-propyl, isopropyl, n-butyl, n-pentyl, benzyl, 3-sulfopropyl, carboxymethyl, trifluoromethyl and chloromethyl groups), alkenyl groups (preferably having 2 to 20 carbon atoms, for example vinyl, allyl, 2-butenyl and 1,3-butadienyl groups), cycloalkyl groups (preferably having 3 to 20 carbon atoms, for example cyclopentyl and cyclohexyl groups), aryl groups (preferably having 6 to 20 carbon atoms, for example phenyl, 2-chlorophenyl, 4-methoxyphenyl, 3-methylphenyl and 1-naphthyl groups, and biphenyl and terphenyl derivatives), heterocyclic groups (preferably having 1 to 20 carbon atoms, for example pyridyl, pyrimidiyl, thienyl, furyl, thiazolyl, imidazolyl, pyrazolyl, pyrrolidino, piperidino and morpholino groups), alkynyl groups (preferably having 2 to 20 carbon atoms, for example ethinyl, 2-propinyl, 1,3-butadinyl and 2-phenylethyl groups), halogen atoms (for example F, Cl, Br and I), amino groups (preferably having 0 to 20 carbon atoms, for example amino, dimethylamino, diethylamino, dibutylamino and anilino groups), cyano group, nitro group, hydroxyl group, mercapto group, carboxyl group, sulfo group, sulfonic acid group, acyl group (preferably having 1 to 20 carbon atoms, for example, acetyl, benzoyl, salicyloyl and pyvaloyl groups), alkoxy groups (preferably having 1 to 20 carbon atoms, for example methoxy, butoxy and cyclohexyloxy groups), aryloxy groups (preferably having 6 to 26 carbon atoms, for example phenoxy and 1-naphthoxy groups), alkylthio groups (preferably having 1 to 20 carbon atoms, for example methylthio and ethylthio groups), arylthio groups (preferably having 6 to 20 carbon atoms, for example phenylthio, 4-chlorophenylthio groups), alkylsulfonyl groups (preferably having 1 to 20 carbon atoms, for example methanesulfonyl and butanesulfonyl groups), arylsulfonyl groups (preferably having 6 to 20 carbon atoms, for example benzenesulfonyl and paratoluenesulfonyl groups), sulfamoyl groups (preferably having 0 to 20 carbon atoms, for example sulfamoyl, N-methylsulfamoyl and N-phneylsulfamoyl groups), carbamoly groups (preferably having 1 to 20 carbon atoms, for example carbamoly, N-methylcarbamoly, N,N-dimethylcarbamoly and N-phenylcarbamoly groups), acylamino groups (preferably having 1 to 20 carbon atoms, for example acetylamino and benzoylamino groups), imino groups (preferably having 2 to 20 carbon atoms, for example phthalimino group), acyloxy groups (preferably having 1 to 20 carbon atoms, for example acetyloxy and benzoyloxy groups), alkoxycarbonyl groups (preferably having 2 to 20 carbon atoms, for example methoxycarbonyl and phneoxycarbonyl groups), carbamoylamino groups (preferably having 1 to 20 carbon atoms, for example carbamoylamino, N-methyl carbamoylamino and N-phenyl carbamoylamino groups) and azo groups (preferably having 1 to 20 carbon atoms, for example phenylazo and naphthylazo groups); and more preferably a hydrogen atom, an alkyl group, an aryl group, a heterocyclic group, a halogen atom, an amino group, a cyano group, a nitro group, a hydroxyl group, a carboxyl group, an alkoxy group, an aryloxy group, an alkylsulfonyl group, an arylsulfonyl group, a sulfamoyl group, a carbamoyl group, an acylamino group, an acyloxy group, an alkoxycarbonyl group and an azo group.

R₂₁ preferably includes one or plural divalent linking groups described in L₁₂ to L₁₄. R₂₁ preferably has a mesogen group linked to a flexible spacer group. The mesogen group is preferably a linear mesogen group used as a mesogen group for usual low molecular weight liquid crystal. Examples of such a mesogen group include biphenyl, terphenyl, benzoic acid ester, cyclohexyl carboxylic acid ester, phenylcyclohexane, pyrimidine, dioxane and cyclohexylcyclohexane mesogen groups containing p- (para-) substituted aromatic rings.

L₁₂ to L₁₄ each independently represent a divalent linking group. Preferable examples thereof include —O—, —OC(O)—, —CONR₁₉—, and arylene groups that may be substituted (preferably having 6 to 26 carbon atoms, for example 1,2-phenylene, 1,3-phenylene, 1,4-phenylene, 1,4-naphthylene and 2,6-naphthylene that may be substituted). R₁₉ represents any one of a hydrogen atom, an alkyl group, an alkenyl group, a cycloalkyl group, an aryl group and a heterocyclic group (examples of the preferable substituent are the same as those in R₂₁), and preferably a hydrogen atom or an alkyl group.

When R₂₁ is a substituent, A₅ represents a trivalent linking group. When R₂₁ is a hydrogen atom, A₅ represents a divalent linking group. Preferable examples thereof include the following. A₅ represented by the following is linked with R₂₁ at the position shown by “*”.

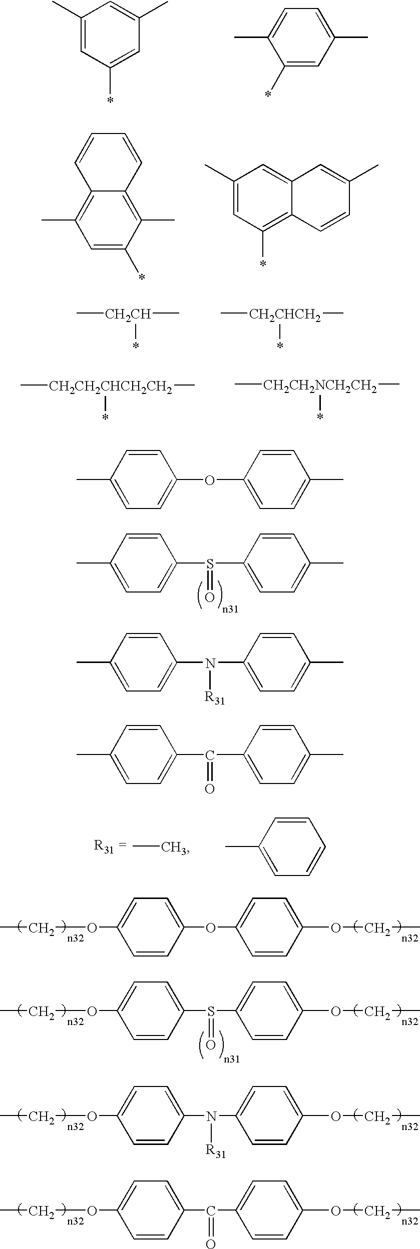

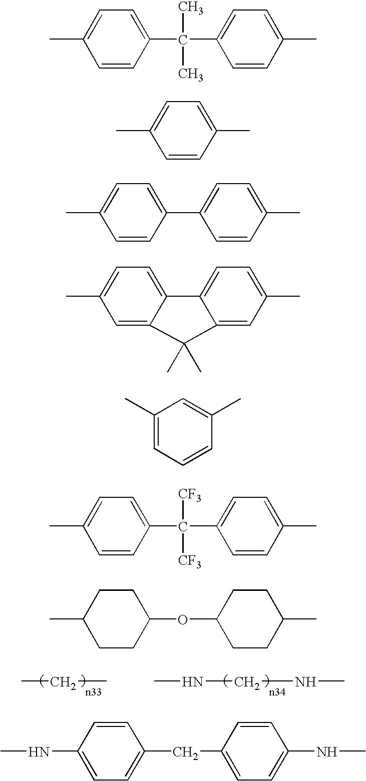

In the above formulae, n31, n32, n33 and n34 represent an integer from 0 to 2, an integer from 2 to 12, an integer from 2 to 12 and an integer from 2 to 8, respectively.

a3 and a4 represent a ratio of a repeating unit that is present in formula (1), and satisfy the relations of 0<a3<1, 0<a4<1, and a3+a4=1. The absorption coefficient of the photo-responsive polyester can be controlled by adjusting the ratio of aforementioned two dicarboxylic acid monomer according to the medium design. The ratio a3 is preferably adjusted from the viewpoints of the influence of an azobenzene derivative that may cause orientation alteration of a biphenyl derivative and the number of azobenzene units contained in one molecule. a3 is preferably from 0.0005 to 0.5, and more preferably from 0.05 to 0.5.

a'3 and a'4 represent a ratio of a repeating unit that is present in formula (1), and satisfy the relations of 0<a'3<1, 0<a'4<1, and a'3+a'4=1. The crystalline characteristics of the photo-responsive polyester can be controlled by adjusting the ratio of aforementioned two constituent units of the main chain according to the medium design. The ratio a'3 is, in view of recording properties and scattering, preferably from 0.2 to 0.95, and more preferably from 0.5 to 0.9.

n1 represents an integer from 4 to 2,000. In other words, the polymer compound of the present invention has a molecular weight preferably in a range of 1,000 to 10,000,000 and more preferably in a range of 5,000 to 1,000,000.

Examples of synthesizing the polymer compound (photo-responsive polymer) represented by formula (1) of the present invention will be described below. However, these examples should not be construed to limit the scope of the invention.

### Synthesis of dicarboxylic acid monomer having cyanobiphenyl: diethyl 5-{6-[4-(4-cyanophenyl)phenoxy]hexyloxy}isophthalate

(1) Synthesis of 4-(6-bromohexyloxy)-4′-cyanobiphenyl

0.2 mol (39 g) of 4-hydroxy-4′-cyanobiphenyl, 2 mol (487.5 g) of 1,6-dibromohexane, 1.45 mol (200 g) of potassium carbonate anhydride and 800 ml of acetone are placed in a 2-liter three-neck flask equipped with a mechanical stirrer and the mixture is reacted under reflux for 20 hours by using a water bath. The reaction mixture is cooled to room temperature and then undissolved salts are removed by filtration. The resulting reaction solution is concentrated to a volume of about ½ by using a rotary evaporator, to which is then added 500 ml of hexane, followed by heating with stirring. Then, the resulting solution is cooled gradually to room temperature and then allowed to stand in a freezing chamber to crystallize. After the crystallized product is subjected to vacuum filtration, it is washed with n-hexane and dried under reduced pressure to obtain a crude target product (yield: 85% (61.3 g)), which is then recrystallized from ethanol to obtain a purified target product 4-(6-bromohexyloxy)-4′-cyanobiphenyl (yield: 58% (41.8 g)).

(2) Synthesis of diethyl 5-hydroxyisophthalate

1 mol (182.4 g) of 5-hydroxyisophthalic acid, 1500 ml of ethanol and 10 ml of concentrated sulfuric acid are placed in a 2-liter three-neck flask and the mixture are reacted under reflux for 24 hours by using a water bath. After the reaction is completed, the system is concentrated to a volume of about ½ by using a rotary evaporator. The resulting solution is poured into a cooled aqueous solution containing about 20% of sodium bicarbonate to precipitate a crude target product as a white flock, which is then separated by filtration and dried under reduced pressure (yield: 96% (229 g)). The crude product is recrystallized from ethanol to obtain diethyl 5-hydroxyisophthalate (yield: 80% (190 g)).

(3) Synthesis of diethyl isophthalate having cyanobiphenyl: diethly 5-{6-[4-(4-cyanophenyl)phenoxy]hexyloxy}isophthalate

0.08 mol (28.8 g) of 4-(6-bromohexyloxy)-4′-cyanobiphenyl, 0.08 mol (16.6 g) of diethyl 5-hydroxyisophthalate, 0.12 mol (19.2 g) of potassium carbonate anhydride and 400 ml of acetone are placed in a 1-liter three-neck flask and the mixture is reacted under reflux for 24 hours by using a water bath. After the reaction solution is allowed to cool, it is poured into about 4 l of purified water to take out a precipitate, which is to be a crude subject product, by filtration and the precipitate is dried under reduced pressure (yield: 90% (37 g)). The resulting precipitate is recrystallized from acetone to obtain diethyl isophthalate having cyanobiphenyl through a hexyl group as a target product (yield: 73% (30 g)). The resulting compound is subjected to nuclear magnetic resonance (NMR) measurement. The results of measurement are shown below. Also, the compound is subjected to mass spectrometry, with the result that a peak corresponding to a molecular weight of 515.6 is confirmed.

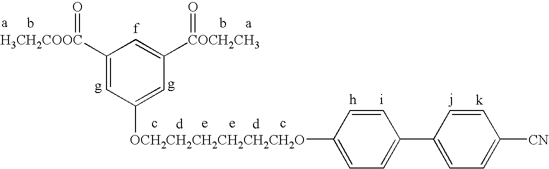

| Position | a | b | c | d | e | f | g | h | i | j | k |
|---|---|---|---|---|---|---|---|---|---|---|---|
| of | | | | | | | | | | | |
| hydrogen | | | | | | | | | | | |
| δ in ppm | 1.41 | 4.40 | 4.05 | 1.86 | 1.58 | 8.26 | 7.74 | 7.00 | 7.71 | 7.62 | 7.74 |

Main chain monomer: Synthesis of 6,6′-(4,4′-sulfonyldiphenylenedioxy)dihexanol

0.3 mol (82.3 g) of 4,4′-sulfonyldiphenol, 0.66 mol (90.2 g) of 6-chloro-1-hexanol and 0.7 mol (97 g) of potassium carbonate anhydride are weighed and mixed and 250 ml of N,N-dimethylformamide is added to the mixture, followed by stirring to suspend. The system is heated to 160° C. using an oil bath and reacted for 24 hours. After that, the reaction solution is poured into water containing a small amount of hydrochloric acid. The generated white powder material is separated by filtration and dried to obtain a crude target product, which is then recrystallized from a water-N,N-dimethylformamide system to obtain purified 6,6′-(4,4′-sulfonyldiphenylenedioxy)dihexanol (yield: 89% (120 g)). The resulting compound is subjected to measurements of infrared absorption spectrum (IR) and nuclear magnetic resonance (NMR). The results are shown in the following. IR: 2937 cm⁻¹ (CH expansion), 1594 cm⁻¹ (C═C), 1252 cm⁻¹ (C—O—C), 1149 cm⁻¹ (S═O)

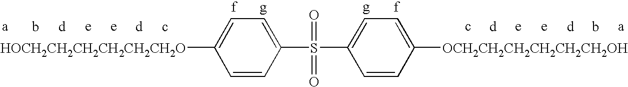

| Postion of hydrogen | a, d, e | b | c | f | g |
|---|---|---|---|---|---|
| δ in ppm | 1.40-1.81 | 3.65 | 3.98 | 6.91 | 7.82 |

### Synthesis of a Photo-responsive Polymer Photo-responsive dicarboxylic acid monomer having methylazobenzene: synthesis of diethyl 5-{6-[4-(4-methylphenylazo)phenoxy]hexyloxy}isophthalate

(1) Synthesis of 4-hydroxy-4′-methylazobenzene

A 3-liter beaker is charged with 750 ml of 6 N hydrochloric acid and then with 107 g (1 mol) of finely pulverized p-anisidine(4-methylaniline). The mixture is sufficiently suspended by stirring and about 300 g of ice is added to the suspension, followed by cooling the system. In the meantime, 80 g (1.16 mol) of sodium nitrite is dissolved in 500 ml of water. 400 ml of the sodium sulfite solution is poured into the suspension over 20 minutes. After completion of the dripping, the solution is stirred at about 5° C. for one hour. To the solution is gradually added a solution obtained by dissolving 94 g (1 mol) of phenol in 1 liter of a 2N potassium hydroxide solution, followed by mixing and the mixture is reacted overnight. After the reaction is completed, the generated precipitate is separated by filtration and dried under reduced pressure to obtain 210 g (almost quantitative) of crude 4-hydroxy-4′-methylazobenzene. The product is subjected to the next reaction without purifying the same. The maximum absorption wavelength (λmax) of the compound is 345 nm.

(2) Synthesis of 4-(6-bromohexyloxy)-4′-methylazobenzene

A 2-liter three-neck flask equipped with a mechanical stirrer is charged with 42.4 g (0.2 mol) of 4-hydroxy-4′-methylazobenzene synthesized in the same manner as in the above example, 448 g (2 mol) of 1,6-dibromohexane and 212 g (1.5 mol) of potassium carbonate anhydride. To the mixture is added 800 ml of acetone and the resulting mixture is suspended by stirring. The reaction system is heated until acetone is refluxed to react hydroxybenzene with bromoalkane. After the reaction is continued for 20 hours, insoluble salts are separated by filtration and removed. The system is concentrated to a volume of about ⅓ by using a rotary evaporator. When the system is cooled in a freezing chamber, 4-(6-bromohexyloxy)-4′-methylazobenzene is produced as a crystal. After the generated product is subjected to filtration, it is washed with a small amount of cool acetone, cool ether and n-hexane in this order and then dried under reduced pressure to obtain 38.1 g of crude 4-(6-bromohexyloxy)-4′-methylazobenzene (yield: 50.8%). The resulting product is recrystallized from ethanol to obtain 32 g (yield: 42%) of 4-(6-bromohexyloxy)-4′-methylazobenzene. It is found from an analysis using high performance liquid chromatography that the purity of the product is 98.6% or more.

(3) Synthesis of diethyl (5-{6-[4-(4-methylphenylazo)phenoxy]hexyloxy}isophthalate

A 1-liter three-neck flask is charged with 16.6 g (0.07 mol) of diethyl 5-hydroxyisophthalate, 26.1 g (0.07 mol) of 4-(6-bromohexyloxy)-4′-methylazobenzene and 15.1 g (0.11 mol) of potassium carbonate anhydride. To the mixture is added 300 ml of acetone and the system is refluxed under heating to react for 24 hours. After the reaction is completed, the system is poured into 1500 ml of cool water to obtain diethyl {6-[4-(4-methylphenylazo)phenoxy]hexyloxy}isophthalate, which is then separated by filtration and dried under reduced pressure (yield: 83% (35.1 g)). The product is recrystallized from acetone twice to obtain 30.1 g (80.1%) of a target product, diethyl (5-{6-[4-(4-methylphenylazo)phenoxy]hexyloxy}isophthalate. It is found from an analysis using high performance liquid chromatography that the purity of the product is 98.5% or more. The resulting compound is subjected to measurements of infrared absorption spectrum (IR) and nuclear magnetic resonance (NMR). The results are shown in the following.

IR: 2938 cm⁻¹ (CH expansion), 1716 cm⁻¹ (ester C═O), 1601 cm⁻¹ (C═C), 1580 cm⁻¹ (N═N), 1246 cm⁻¹ (C—O—C)

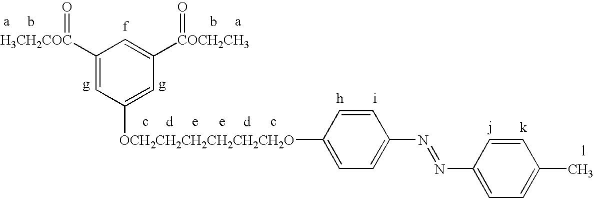

| Position of | a | b | c | d | e | f | g | h, k | i, j | l |
|---|---|---|---|---|---|---|---|---|---|---|
| hydrogen | | | | | | | | | | |
| δ in ppm | 1.41 | 4.41 | 4.05 | 1.87 | 1.58 | 8.27 | 7.75 | 6.98-7.01 | 7.85-7.88 | 3.88 |

### Photo-responsive Polymer: Synthesis of a Polyester having Cyanobiphenyl and Methylazobenzene at a Side Chains

Diethyl (5-{6-[4-(4-cyanophenyl)phenoxy]hexyloxy}isophthalate as a dicarboxylic acid monomer having cyanobiphenyl, diethyl 5-{6-[4-(4-methylphenylazo)phenoxy]hexyloxy}isophthalate as a photo-responsive dicarboxylic acid monomer having methylazobenzene and 6,6′-(4,4′-sulfonyldiphenylenedioxy)dihexanol as a main chain portion monomer are used to synthesize four types of polymer different in the copolymerization ratio of the dye (methylazobenzene) side chain. The polymers are synthesized by melt polycondensation, in which zinc acetate anhydride is used as a catalyst. The mixing ratios of the materials in each synthesis are found in Table 2. The yield, number average molecular weight and glass transition temperature of each resulting polymer are shown in Table 1. These polymers are transparent amorphous polymers free from scattering.

TABLE 1

| | | Number | |
|---|---|---|---|
| Copolymerization | | average | Glass |
| ratio of the dye | Yield | molecular | transition |
| side chain | (yield amount) | weight | temperature |
| Polymer 1 | 75.8% (3.73 g) | 8540 | 53° C. |
| (100%: x = 1, y = 0) | | | |
| Polymer 2 | 82.1% (4.00 g) | 8462 | 53° C. |
| (50%: x = 0.5, | | | |
| y = 0.5) | | | |
| Polymer 3 | 76.0% (3.70 g) | 8561 | 51° C. |
| (33%: x = 0.33, | | | |
| y = 0.67) | | | |
| Polymer 4 | 81.5% (3.95 g) | 7957 | 52° C. |
| (20%: x = 0.2, | | | |
| y = 0.8) | | | |

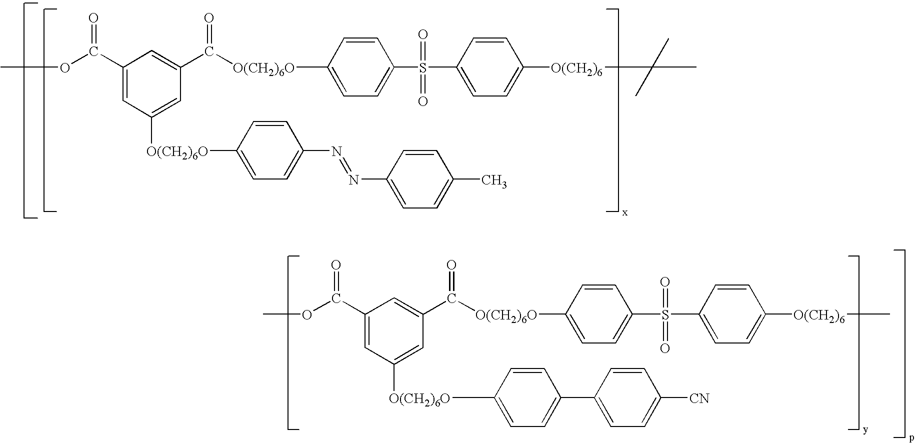 TABLE 2

| | | Side chain | | |
|---|---|---|---|---|
| | Side chain | portion | | |
| | portion | monomer | Main | |
| Copolymerization | monomer | having | chain | |
| ratio of the dye | having | methyl- | portion | Zinc |
| side chain | cyanobiphenyl | azobenzene | monomer | acetate |
| Polymer 1 | 0 g | 2.66 g | 2.25 g | 0.05 g |
| (100%: x = 1, | | | | |
| y = 0) | | | | |
| Polymer 2 | 1.29 g | 1.33 g | 2.25 g | 0.05 g |
| (50%: x = 0.5, | | | | |
| y = 0.5) | | | | |
| Polymer 3 | 1.72 g | 0.89 g | 2.25 g | 0.05 g |
| (33%: x = 0.33, | | | | |
| y = 0.67) | | | | |
| Polymer 4 | 2.06 g | 0.53 g | 2.25 g | 0.05 g |
| (20%: x = 0.2, | | | | |
| y = 0.8) | | | | |

### Photo-responsive Polymer: Synthesis of a Polyester Containing two Types of Main Chain Structure Parts and having Cyanobiphenyl and Methylazobenzene as Side Chains

Six types of polymers varing in the copolymerization ratio of main chain part monomers are produced in the same manner as in the above example of the synthesis of a polyester by using diethyl 5-{6-[4-(4-cyanophenyl)phenoxy]hexyloxy}isophthalate as a dicarboxylic acid monomer having cyanobiphenyl, diethyl 5-{6-[4-(4-methylphenylazo)phenoxy]hexyloxy}isophthalate as a photo-responsive dicarboxylic acid monomer having methylazobenzene, 6,6′-(4,4′-sulfonyldiphenylenedioxy)dihexanol as a main chain part monomer and 6,6′-(4,4′-oxydiphenylenedioxy)dihexanol synthesized in the same manner as the above dihexanol. The structural general formula of each synthesized polymer is shown below. The ratio x of the photo-responsive side chain is 0.1, and each ratio r of the main chain part monomer having an ether bond is 0, 0.1, 0.5, 0.8, 0.9 and 1.0.

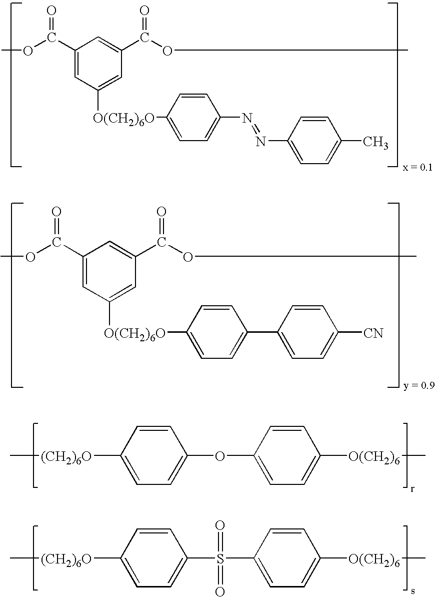

The thickness of the recording layer 14 is 0.1 mm to 5 mm. In order to further increase the recording capacity, the thickness of the recording layer is required to be at least 0.2 mm. In contrast, it is not desirable to increase the thickness of the recording layer to over 5 mm. If the thickness is more than 5 mm, a pigment concentration must be lowered for decreasing an absorption loss. Such reduction in the pigment concentration causes reduction in birefringence. The thickness over 5 mm is not preferable also from the viewpoint of increase in scattering. The thickness of the recording layer 14 is preferably from 0.2 mm to 5 mm, and more preferably 0.5 mm to 5 mm. The method of producing the recording layer will be described below.

(Method of Producing an Optical Recording Medium)

The following description will discuss one example of the method of producing the optical recording medium as described above. In the present embodiment, after a disc-shaped molded matter that will function as a recording layer has been produced by an injection molding process, this disc-shaped molded matter is sandwiched between a pair of disc-shaped transparent substrates, and bonded to each other by hot pressing. That is, a hot-melt bonding process is carried out.

-Injection molding process-

In the injection molding process, a raw material resin is heated and melted, and the melted resin is injected into a metal mold, and molded into a disc-shape. Examples of the injection molding machine that can be used include an inline-system injection-molding machine having integrally both functions of plasticizing a raw material and injecting a melted raw material, and a pre-plunger-system injection-molding machine having the plasticizing function and the injection molding separately. Conditions of the injection molding are: an injection pressure of 1000 to 3000 kg/cm² and an injection rate of 5 to 30 mm/sec.

-Hot press process-

In the hot press process, the molded matter having a thickness of 0.1 to 5 mm obtained by the injection molding process, is sandwiched between a pair of disc-shaped transparent substrates, and hot-pressed under vacuum.

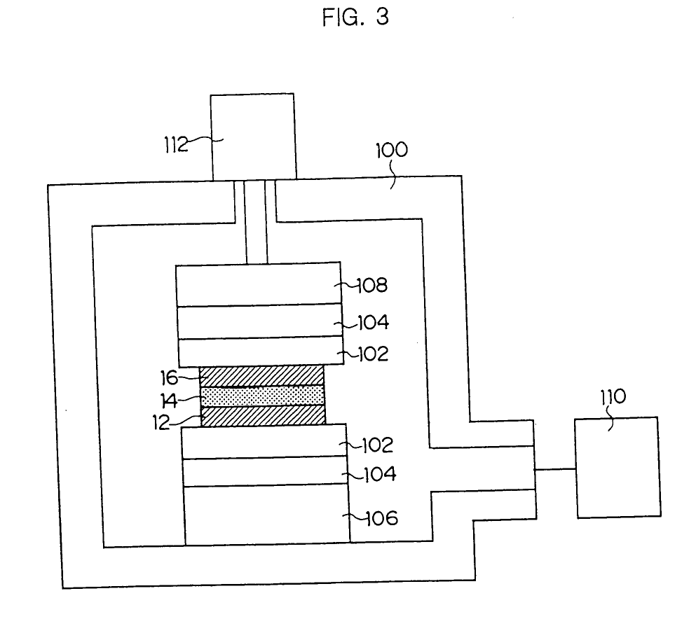

As shown in FIG. 3, a vacuum hot press device has an arrangement in which a pair of holders 102 and a pair of heaters 104 that respectively heat the holders 102 are placed in a vacuum device 100. The holder 102 and the heater 104 on the lower side are held on a holding base 106, and the holder 102 and the heater 104 on the upper side are held at a predetermined height by a holding member 108. Moreover, the vacuum device 100 is further provided with a vacuum exhauster 110 and a pressing device 112 for pressing the upper-side holder 102 via the holding member 108.

First, a sample, prepared by sandwiching the molded matter (referred to as recording layer 14 for convenience of explanation) obtained through the injection molding between the transparent substrates 12 and 16, is loaded between the holders 102. Next, after evacuation of the inside of the vacuum device 100 by using the vacuum exhauster 110, the holder 102 is gradually heated by a heater 104. The gauge pressure of the reduced pressure is preferably set to approximately 0.1 MPa. After confirming that the temperature of the holder 102 has reached a predetermined temperature, a predetermined hydrostatic pressure is applied to the upper-side holder 102 by a pressing device 112 so that the sample is hot-pressed. The heating temperature is preferably a temperature not less than Tg of the recording layer 14, and the pressing pressure is preferably from 0.01 to 0.1 t/cm². After the hot-pressing process has been carried out for a predetermined period of time, the heating and pressing are stopped, and after the sample has been cooled to room temperature, the sample is taken out.

Through the hot-pressing process, the surface of the recording layer 14 having Tg lower than that of the transparent substrates 12 and 16 is melted, and the transparent substrates 12 and 16 are hot-melt bonded to both surfaces of the recording layer 14 to obtain an optical recording medium. Moreover, during the hot-pressing process, the residual distortion of the molded matter caused by the injection molding is uniformed.

As described above, in the present embodiment, the recording layer is not formed on the substrate, but independently formed by the injection molding. Therefore, thicker recording layers are easily obtained. Also the embodiment is suitable to mass production of optical recording media. Moreover, since the recording layer and the transparent substrate are bonded to each other through the hot-pressing process, the residual distortion of the molded matter caused by the injection molding is uniformed so that even when the recording layer is made equal to or thicker than 0.1 mm in thickness, the recording characteristics are not damaged by the influence of light absorption or scattering.

### Second Embodiment

(Optical Recording Medium)

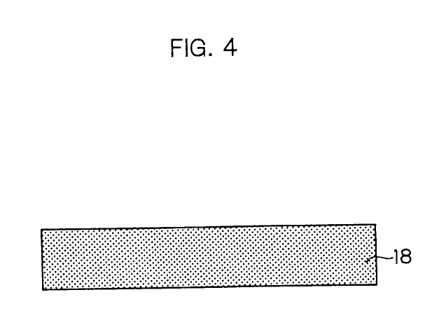

As shown in FIG. 4, an optical recording medium according to a second embodiment is constituted only by the plate-shaped recording layer 18. The recording layer 18 can be composed of the same materials as the recording layer 14 of the optical recording medium 35 of the first embodiment.

Similarly as in the case of the recording layer 14, the thickness of the recording layer 18 is from 0.1 mm to 5 mm. The thickness of the recording layer 18 is preferably from 0.5 mm to 5 mm, and more preferably from 1 mm to 5 mm. The method of producing the recording layer will be described later.

Additionally, a protective layer for improving scratch resistance and moisture resistance of the optical recording medium and an antireflection layer may be formed, if necessary. With respect to the materials used for the protective layer, examples thereof include: inorganic substances such as SiO, SiO₂, MgF₂, SnO₂ and Si₃N₄ and organic substances such as thermoplastic resin, thermocurable resin and photocurable resin.

(Method of Producing an Optical Recording Medium)

The following description will discuss one example of the method of producing the aforementioned optical recording medium. In this embodiment, powdered resin is sandwiched between substrates having a high mold-releasing property such as Teflon (TM) sheets, and hot-press under vacuum in this state to be directly molded into a recording layer 18.

-Hot press process-

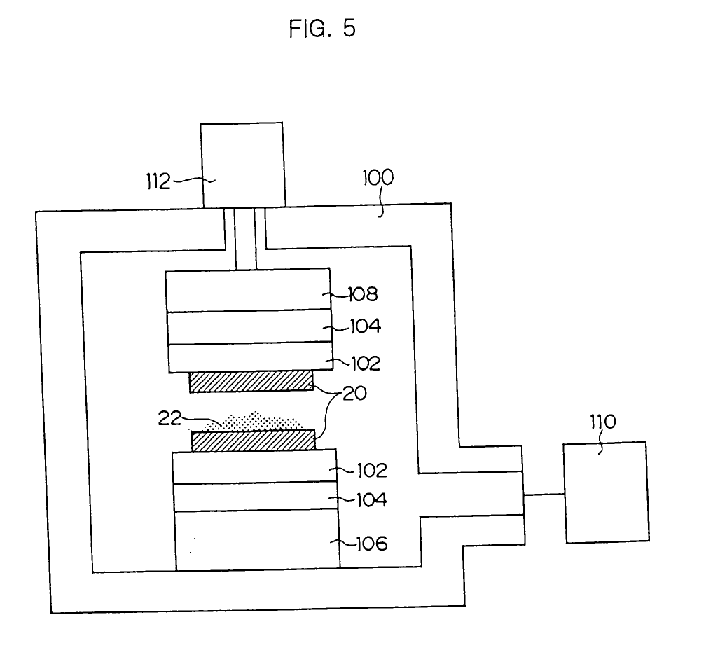

As shown in FIG. 5, by using a vacuum hot-press device shown in FIG. 3, Teflon (TM) sheets 20 are attached to the respective upper and lower holders 102. A resin material 22 in powder state, used for forming a recording layer 18, is placed on the lower-side Teflon (TM) sheet 20 as a sample. In the same manner as the first embodiment, after the inside of the vacuum device 100 is evacuated by the vacuum exhauster 110, the holder 102 is gradually heated by a heater 104. The gauge pressure of the reduced pressure is preferably approximately 0.1 MPa in order to prevent generation of bubbles. After confirming that the temperature of the holder 102 has reached a predetermined temperature, a predetermined hydrostatic pressure is applied to the upper-side holder 102 by a pressing device 104 so that the sample sandwiched between the Teflon (TM) sheets is hot-pressed. The heating temperature is preferably at least Tg of the resin material 22, with the pressing pressure being 0.01 to 0.1 t/cm². After the hot-pressing process has been carried out for a predetermined period of time, the heating and pressing are stopped, and after the sample has been cooled to room temperature, the sample is taken out.

Through the hot-press process, the resin material 22, sandwiched between the Teflon (TM) sheets 20 is heated and melted, then cooled to obtain a plate-shaped recording layer 18. Lastly, the Teflon (TM) sheets 20 are removed to obtain an optical recording medium. For example, in the case when the recording layer 18 is composed of azopolymer, since Tg of the azopolymer is as low as 50° C., the azopolymer is heated to approximately 70° C. and subjected to a hot-press process so that the recording layer 18 is easily molded to have a predetermined thickness. Further, the hot-press process generates no residual distortion.

As described above, in the present embodiment, the recording layer is not formed on a substrate, but individually formed by the hot-press process; therefore, it is possible to easily provide a thicker recording layer. Moreover, the recording layer is molded by the hot-press process, with the result that no residual distortion and the like in the molded matter are generated; thus, even in the case of a thick recording layer of at least 0.1 mm, the recording characteristics are not damaged by the influence of light absorption or scattering.

In the above-described embodiments, examples raised in the above include an example in which the recording layer is bonded to the transparent substrates through hot-pressing and another example in which the recording layer is molded through hot-pressing. However, in the case when azopolymer is used for forming the recording layer, it is possible to provide a recording layer having good recording characteristics by using only the injection-molding process.

What is claimed is:

1. An optical recording medium comprising a recording layer which is formed into a predetermined shape with a thickness of 0.1 mm to 5 mm and which contains a polyester represented by the following formula (1): 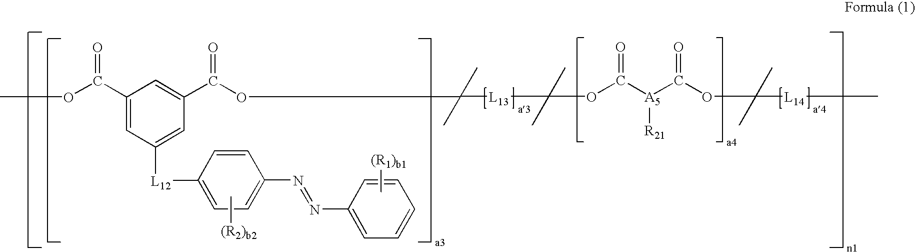
wherein R₁ and R₂ each independently represent a hydrogen atom or a substituent; b1 represents an integer from 0 to 5; b2 represents an integer from 0 to 4; when b1 is 2 or more, a plurality of R₁ may be the same as or different from each other and the plurality of R₁ may form a ring by being linked with each other; when b2 is 2 or more, a plurality of R₂ may be the same as or different from each other and the plurality of R₂ may form a ring by being linked with each other; R₂₁ represents a hydrogen atom or a substituent; A₅ represents a divalent linking group when R₂₁ is a hydrogen atom, and A₅ represents a trivalent linking group when R₂₁ is a substituent; L₁₂ to L₁₄ each independently represent a divalent linking group; a3 represents a number from 0.0001 to 1; a4 represents a number from 0 to 0.9999; a3 and a4 satisfy a3+a4=1; a'3 represents a number from 0 to 1; and a'4 represents a number from 0 to 1; a'3 and a'4 satisfy a'3+a'4=1; and n1 represents an integer from 4 to 2000.

2. The optical recording medium of claim 1, wherein R₂ has a mesogen group linked to a flexible spacer group.

3. The optical recording medium of claim 1, wherein the recording layer is formed into a plate shape and is sandwiched between a pair of protective substrates.

4. A method of producing an optical recording medium in which a recording layer comprising a photo-responsive polymer material is sandwiched between a pair of protective substrates, the method comprising:
injection molding the photo-responsive polymer material into a plate shape having a thickness of 0.1 mm to 5 mm; and
hot-pressing the molded polymer material sandwiched between the pair of protective substrates so that the molded polymer material is fused with the pair of protective substrates to form an optical recording medium.

5. The method of claim 4, wherein the protective substrates are transparent plastic substrates.

6. The method of claim 4, wherein the protective substrates have a Tg which is higher than a Tg of the recording layer.

7. The method of claim 4, wherein the recording layer is a photo-responsive material that exhibits photo-induced birefringence.

8. The method of claim 7, wherein the photo-responsive material comprises at least one selected from the group consisting of a polymer having a photo-isomerizable group on a side chain thereof, a polymer crystal having a photo-isomerizable group on a side chain thereof, and a polymer in which photo-isomerizable molecules are dispersed.

9. The method of claim 4, wherein the photo-responsive polymer material contains a polyester represented by the following formula (1): 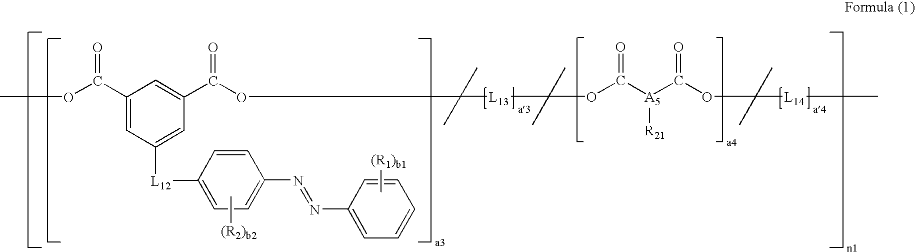
wherein R₁ and R₂ each independently represent a hydrogen atom or a substituent; b1 represents an integer from 0 to 5; b2 represents an integer from 0 to 4; when b1 is 2 or more, a plurality of R₁ may be the same as or different from each other and the plurality of R₁ may form a ring by being linked with each other; when b2 is 2 or more, a plurality of R₂ may be the same as or different from each other and the plurality of R₂ may form a ring by being linked with each other; R₂ represents a hydrogen atom or a substituent; A₅ represents a divalent linking group when R₂₁ is a hydrogen atom, and A₅ represents a trivalent linking group when R₂₁ is a substituent; L₁₂ to L₁₄ each independently represent a divalent linking group; a3 represents a number from 0.0001 to 1; a4 represents a number from 0 to 0.9999; a3 and a4 satisfy a3+a4=1; a'3 represents a number from 0 to 1; and a'4 represents a number from 0 to 1; a'3 and a'4 satisfy a'3+a'4=1; and n1 represents an integer from 4 to 2000.

10. The method of claim 9, wherein R₂₁ has a mesogen group linked to a flexible spacer group.

11. A method of producing an optical recording medium having a recording layer comprising a photo-responsive polymer material, the method comprising:
forming the photo-responsive polymer material into a plate shape having a thickness of 0.1 mm to 5 mm by hot-pressing; and
using the formed polymer material to produce an optical recording medium.

12. The method of claim 11, wherein the recording layer comprises a photo-responsive material that exhibits photo-induced birefringence.

13. The method of claim 12, wherein the photo-responsive material comprises at least one selected from the group consisting of a polymer having a photo-isomerizable group on a side chain thereof, a polymer crystal having a photo-isomerizable group on a side chain thereof, and a polymer in which photo-isomerizable molecules are dispersed.

14. The method of claim 11, wherein the optical recording medium further comprises a protective layer or an antireflection layer.

15. The method of claim 11, wherein the photo-responsive polymer material contains a polyester represented by the following formula (1): 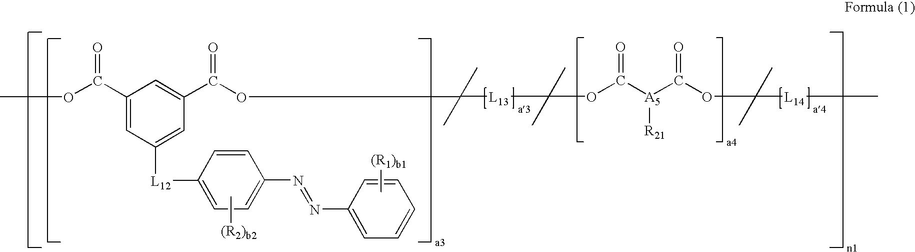
wherein R₁ and R₂ each independently represent a hydrogen atom or a substituent; b1 represents an integer from 0 to 5; b2 represents an integer from 0 to 4; when b1 is 2 or more, a plurality of R₁ may be the same as or different from each other and the plurality of R₁ may form a ring by being linked with each other; when b2 is 2 or more, a plurality of R₂ may be the same as or different from each other and the plurality of R₂ may form a ring by being linked with each other; R₂₁ represents a hydrogen atom or a substituent; A₅ represents a divalent linking group when R₂₁ is a hydrogen atom, and A₅ represents a trivalent linking group when R₂₁ is a substituent; L₁₂ to L₁₄ each independently represent a divalent linking group; a3 represents a number from 0.0001 to 1; a4 represents a number from 0 to 0.9999; a3 and a4 satisfy a3+a4=1; a'3 represents a number from 0 to 1; and a'4 represents a number from 0 to 1; a'3 and a'4 satisfy a'3+a'4=1; and n1 represents an integer from 4 to 2000.

16. The method of claim 15, wherein R₂₁ has a mesogen group linked to a flexible spacer group.
